(19) United States
(12) Patent Application Publication
(10) Pub. No.: US 2008/0251317 A1
(43) Pub. Date: Oct. 16, 2008

(54) STEP STOOL KIT

(75) Inventor: Benjamin D. Johnson, Columbus, IN (US)

Correspondence Address: BARNES & THORNBURG LLP, 11 SOUTH MERIDIAN, INDIANAPOLIS, IN, 46204, US

(73) Assignee: COSCO MANAGEMENT, INC., Wilmington, DE (US)

(21) Appl. No.: 12/098,953

(22) Filed: Apr. 7, 2008

Related U.S. Application Data
(60) Provisional application No. 60/911,012, filed on Apr. 10, 2007.

(51) Int. Cl. E06C 7/16

(52) U.S. Cl. 182/120

(57) ABSTRACT

A step stool kit includes a base unit and a step unit. The step unit rests on the base unit and includes an upper step. The base unit includes a lower step.

This application claims priority under 35 U.S.C. §119(e) to U.S. Provisional Patent Application Ser. No. 60/911,012, filed on Apr. 10, 2007, the contents of which are expressly incorporated herein by reference.

### BACKGROUND

The present disclosure relates to stools, particularly to step stools. More particularly, the present disclosure is related to a multi-part step stool.

In a simple example, a step stool provides a single step onto which a user may climb to increase the effective reach of the user by increasing a height accessible by the user.

In a more complex example, a step stool may present a multi-step configuration. In the multi-step configuration, the step stool presents two or more surfaces on which the user may stand, further increasing the effective reach of the user.

### SUMMARY

A step stool in accordance with the present disclosure includes a lower step and an elevated upper step. In illustrative embodiments, the lower step is included in a base unit and the upper step is included in a separate step unit.

In illustrative embodiments, a step stool kit may be assembled in the field in one way to produce a multi-step configuration and in another way to produce a nested configuration. A step stool kit provides elements that may be configured in at least two modes to extend a user's reach.

In illustrative embodiments, the step stool kit may include a base unit with a base platform supported by a plurality of base legs and configured to include the lower step. The step stool kit also may include a step unit with a step platform supported by a plurality of step legs and configured to include the upper step.

In one contemplated embodiment, the step stool kit may be assembled in the multi-step configuration such that the base platform is disposed a first distance below the step platform. In another contemplated configuration, the step stool kit may be assembled in the nested configuration such that the base platform is disposed a second distance below the step platform. For some embodiments, it is contemplated that the second distance is less than the first distance such that the multi-step configuration presents a taller profile than the nested configuration.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompany figures in which:

FIG. 1 is a five-part, diagrammatic view of a step stool kit in accordance with the present disclosure showing a step stool kit in a nested mode (or configuration) and in a multi-step mode (or configuration), where, in the nested mode, a base unit nests within a step unit, and, in the multi-step mode, the base unit is assembled by displacement of the base unit, rotation of the base unit with respect to the step unit, and coupling of the step unit and the base unit to form a multi-step configuration;

FIG. 2 is an exploded perspective view of one contemplated embodiment of a step stool kit showing (from top to bottom) the step unit, the base unit, and three caster units, the caster units being coupled to the base unit, among other features;

FIG. 3 is a perspective view of the step stool kit showing the nested mode, where the base unit is nested within the step unit;

FIG. 4 is a perspective view of the step stool kit of FIG. 2 showing the step stool kit in the multi-step mode where the step unit is coupled atop the base unit, thereby presenting two steps for use by the user of the step stool kit;

FIG. 5 is a plan view of the step stool kit in the multi-step mode, showing the step stool kit in a neatly-fitting position within a corner of a wall, for example; and

FIG. 6 is a side elevation view of one contemplated embodiment of the step unit showing a step platform, coupled to an upper end of step unit legs, with a pair of lock tabs extending downwardly depending from a bottom end of each step unit leg, the lock tabs being configured to engage apertures in a top surface of the base unit so that the step unit and the base unit may be coupled to establish the multi-step mode or configuration.

### DETAILED DESCRIPTION

While a step stool kit is described in connection with specific, enumerated embodiments, the enumerated embodiments are not intended to be limiting. To the contrary, the enumerated embodiments are intended to illustrate the broad scope of the step stool kit, as should be appreciated by those skilled in the art.

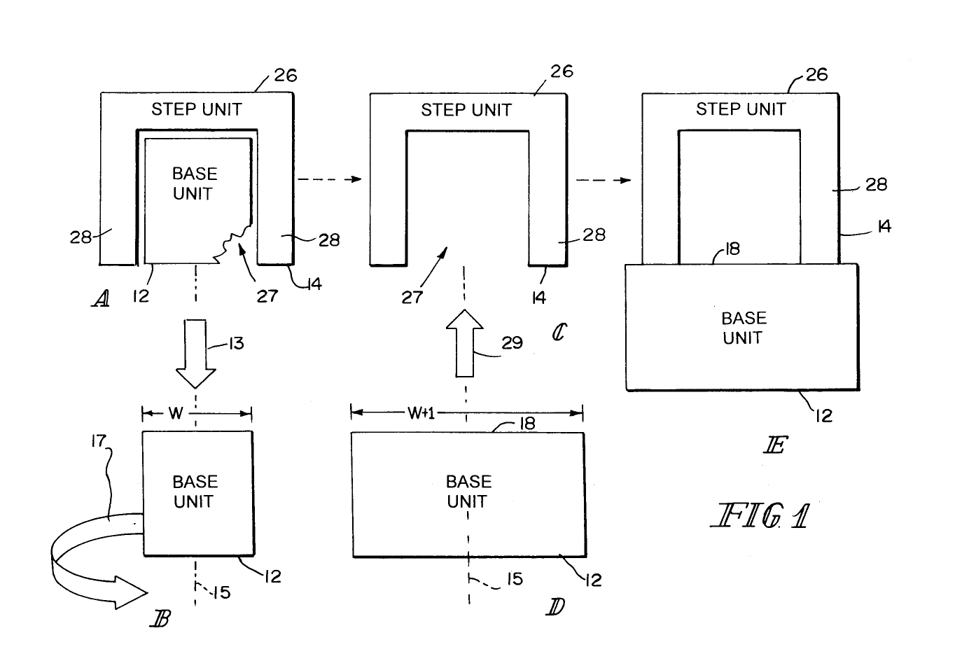

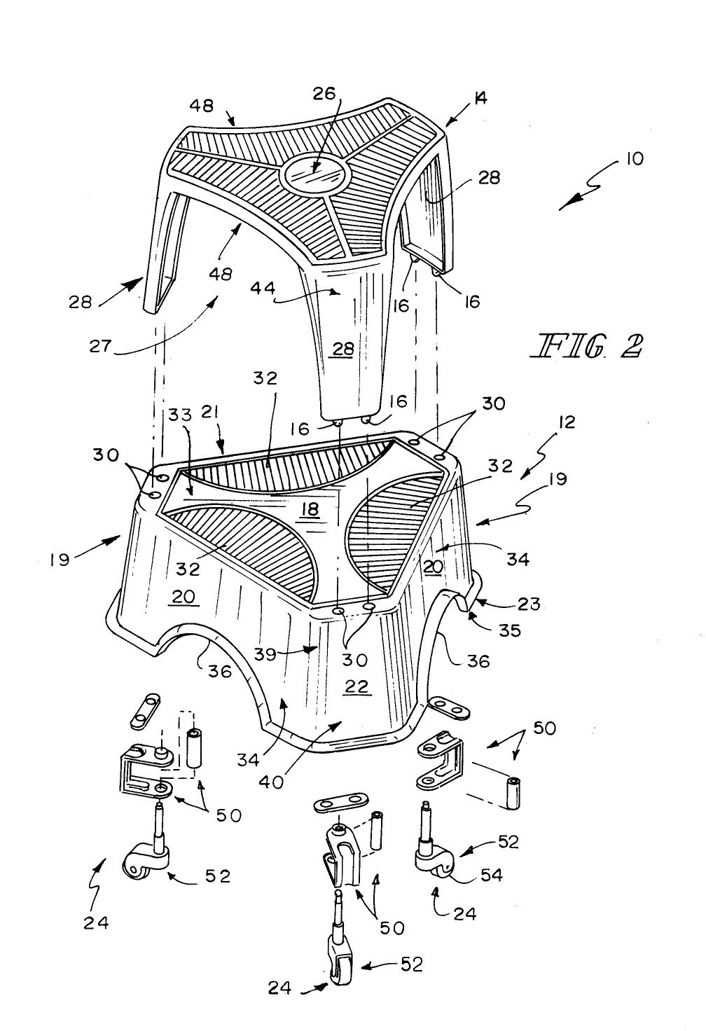

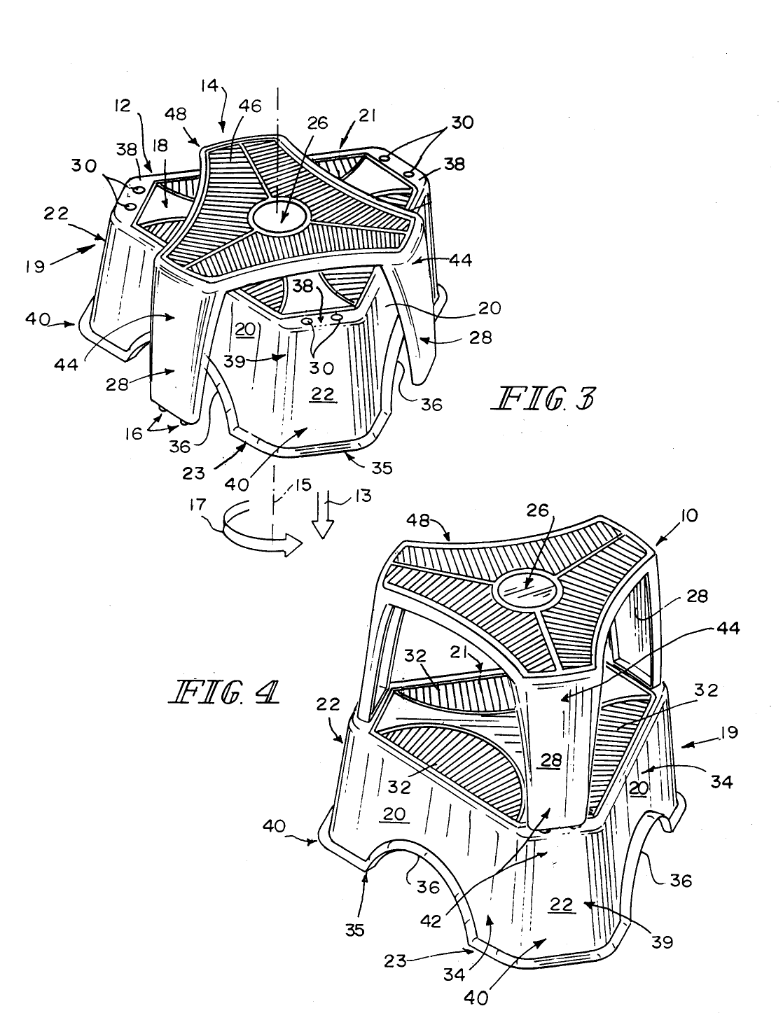

Five diagrammatic illustrations of the step stool kit 10 are presented in FIG. 1. As should be appreciated by those skilled in the art, the five views are not intended to be limited to a particular configuration for the step stool kit 10. While FIGS. 2-6 illustrate one particular configuration, in particular, a substantially triangular configuration, the step stool kit 10 may be configured in any of a number of different shapes and sizes. For example, the step stool kit 10 may be configured as a square, rectangle, polygon, circle, oval, ellipse, or any other suitable shape.

With reference to FIG. 1, in its most basic configuration, the step stool kit 10 includes a base unit 12 and a step unit 14. The base unit 12 and the step unit 14 are configured so that the step stool kit 10 may be assembled in the field to form two configurations, a nested configuration and a multi-step configuration. The nested configuration is indicated by the label “A” and the multi-step configuration is indicated by the label “E” in FIG. 1. Further details of these two configurations are provided below.

It is noted, with reference to FIG. 2, for example, that the step unit 14 is contemplated to include lock tabs 16 at bottom ends of the step legs 28. The locking tabs will be described in greater detail below, with reference to FIGS. 2-4, for example. As should be apparent from FIG. 1, the step stool kit 10 provides two or more steps for a user to increase the user's elevational reach. In addition, the step stool kit 10 facilitates execution of tasks where one or more elevations are desirable to the user.

In operation, step stool kit 10 is received by the user in a nested mode as shown by A in FIG. 1. The step unit 14 includes a step platform 26 and step legs 28 to support the step platform 26. As is apparent from the diagrammatic illustration in FIG. 1, the step platform 26 and the legs 28 cooperate to form a nesting space 27, which is sized to receive the base unit 12 therein in the nested configuration.

It is noted in FIG. 1 that the base unit 12 includes a base platform 18, which provides one surface (e.g., a lower step) on which the user may step to expand his or her elevational reach. The step platform 26 presents a second surface (e.g., an upper step) on which the user may step to increase his or her elevational reach. As should be apparent from the illustration of the nested configuration A in FIG. 1, the step platform 26 is the only platform available for use by the user. In the multi-step configuration, as depicted in E in FIG. 1, both the base platform 18 and the step platform 26 are available as surfaces on which the user may step to increase his or her elevational reach.

The step stool kit 10 is contemplated to be shipped to a user in the nested configuration, since this presents a compact arrangement, which reduces shipping cost. However, it is expected that the user may use the step stool kit 10 in either the nested configuration or in the multi-step configuration. As should be appreciated by those skilled in the art, it is also contemplated that the user may use either the base unit 12 or the step unit 14 individually. As such, the user may rely on only one of the individual components of the step stool kit 10 to extend his or her elevational reach.

With continued reference to FIG. 1, the step stool kit 10 is assembled by moving the base unit 12 and the step unit 14 away from one another in a direction 13 to remove the base unit 12 from the nesting space 27. This operation may be understood with reference to A and B in FIG. 1. In the illustrated configuration, the base unit 12 is then rotated about an axis 15, in a direction 17, to properly align coupling elements of the base unit 12 with the step unit 14. An apparent first width, W, of the base unit 12 is narrower than an apparent second width, W+1. As such, after rotation of the base unit 12 with respect to the step unit 14, the second width, W+1, is aligned to be in register with a third width of the step unit 14. Once the second width, W+1, and the third width are in register, the step unit 14 may be affixed atop the base unit 12, as illustrated in E in FIG. 1.

It is noted that the first width, W, is less than the second width, W+1, as illustrated. In addition, it is noted that the third width is less than the second width, W+1, which permits the step unit 14 to be positioned atop the base unit 12. As noted above, the first width, W, is such that the base unit 12 may be nested within the step unit 14 in the nested configuration. As should be appreciated by those skilled in the art, the third width is contemplated to be greater than the first width, W. However, certain configurations and geometries of the base unit 12 and the step unit 14 may dictate that the third width may be less than or equal to the first width, W.

Once aligned properly, the base unit 12 and the step unit 14 are moved toward one another in a direction 29 as illustrated in C and D in FIG. 1. The base unit 12 and the step unit 14 are then coupled to one another to establish the multi-step configuration, which is shown in E in FIG. 1.

With reference to the embodiment of the step stool kit 10 shown in FIG. 1, the base unit 12 includes a base platform 18, a skirt portion 19, and casters 24. The base unit 12 provides a mounting platform for the step unit 14 and allows the user to move the step stool kit 10 by a propelling force applied by a foot of the user. The base unit 12 is positioned to lie adjacent to an underlying surface (not shown) for relative movement thereon. The underlying surface may be a floor, for example.

In the embodiment shown in FIG. 2, the skirt portion 19 is generally triangularly shaped and includes three base legs 22 and three generally flat side walls 20 extending between the three base legs 20. As suggested by FIG. 5, the side walls 20 cooperate to form an included angle 25 of about 60°. Because the side walls 20 have a straight bottom edge, the user may place the step stool kit 10 neatly in a corner 11.

While a triangular configuration (or approximately triangular configuration) is contemplated for the step stool kit 10, in particular a configuration presented to approximate an equilateral triangle, other triangular configurations may be employed. For example, the step stool kit 10 may be configured as an isosceles, acute, or obtuse triangle.

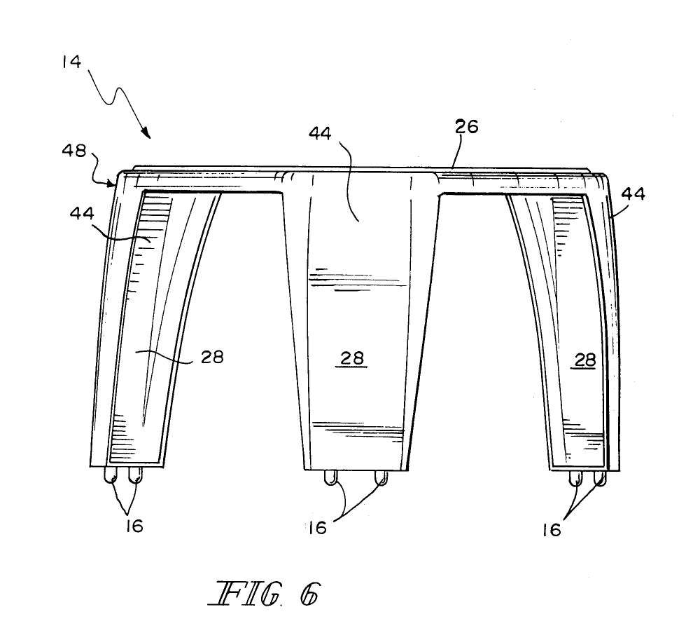

The lock tabs 16 are coupled to a bottom end of the step legs 28 and are positioned to depend therefrom as shown best, for example, in FIG. 6. In illustrative embodiments, a pair of lock tabs 16 depends from each step leg 28. The lock tabs 16 are arranged to engage a pair of apertures 30 formed on an upper end of each base leg 22 to couple step unit 14 and base unit 12 to provide the use position of step stool kit 10.

The base platform 18 includes three step surfaces 32 and a generally Y-shaped divider 33 configured to define step surfaces 32, as shown in FIG. 2. It is noted that three step surfaces are not required. As greater or fewer number may be employed. In illustrative embodiments, the step surfaces 32 are covered with a non-slip textured material to inhibit slippage of a foot of the user when stepping on the step surfaces 32. Each of the step surface 32 is positioned adjacent to one of the side walls 20.

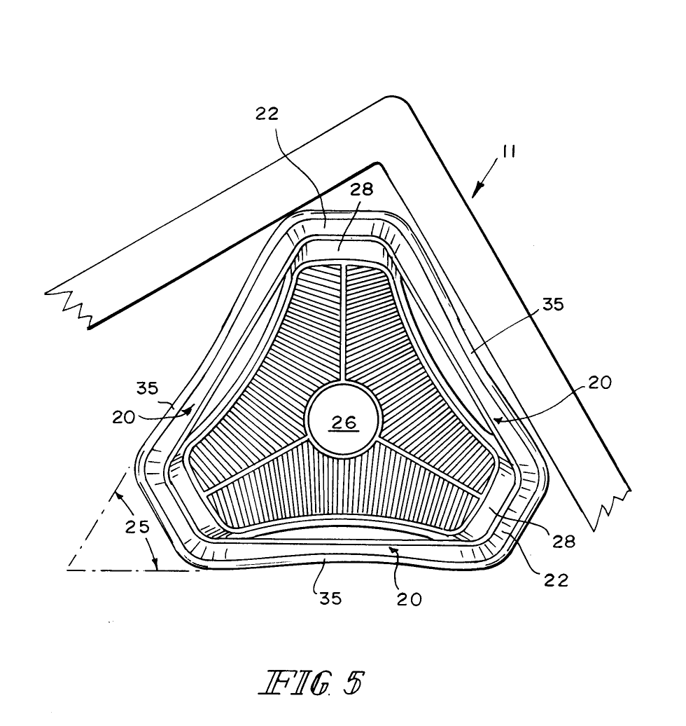

In illustrative embodiments, each side wall 20 includes a flat surface 34, a high-friction bumper strip 35, and a foot receiver 36 formed therein as shown in FIG. 4. The flat surface 34 is coupled to a perimeter edge of the base platform 18 and extends downwardly and slightly outwardly therefrom so that a lower perimeter edge 23 of the base unit 12 is larger than an upper perimeter edge 21 of the base unit 12. Each flat surface 34 extends between and interconnects with a pair of the base legs 22. The bumper strip 35 is coupled to a lower edge of base unit 12 and presented toward the underlying surface for frictional engagement therewith.

The foot receiver 36 is a concave-shaped, downwardly opening aperture formed in a lower portion of each flat surface 34 as shown, for example, in FIG. 4. The foot receiver 36 is arranged to receive the foot of the user to grasp a portion of the flat surface 34 so that the user can move rolling step stool to a desired location without bending over to do so.

The base legs 22 include a top surface 38 formed to include the apertures 30, a narrower upper portion 39, and a wider lower portion 40, which is wider than the narrower upper portion 39, as shown in FIGS. 2-4. When the step stool kit 10 is configured in the multi-step mode, as illustrated in FIG. 4, the base legs 22 and the step legs 28 are aligned in an end-to-end arrangement and cooperate to define risers 42. The risers 42, therefore, extend from lower portion 40 to an upper portion 44 of the step legs 28.

The step platform 26 is generally triangularly shaped and is positioned to lie in a spaced-apart relationship with the base platform 18 when the step stool kit 10 is in the multi-step configuration as shown in FIG. 4. In illustrative embodiments, the step platform 26 is covered with a non-slip textured material to inhibit slippage of the foot of the user when stepping on an upper surface 46 of the step platform 26. A perimeter edge 48 of the step platform 26 is smaller than the upper perimeter edge 21 of the base unit 12, as shown in FIG. 6.

The caster unit 24 includes a mount 50 coupled to an inwardly facing surface of the base leg 20, a retractor 52 coupled to mount 50, and a caster 54 coupled to retractor 52, as shown in FIG. 2. The retractor 52 is coupled to the mount 50 to provide means for stabilizing the base unit 12 when the user steps onto the base platform 18 or the step unit 14.

As the user places weight on the step stool kit 10, the retractors 52 move in an upwardly direction relative to the mounts 50, which act to collapse the base unit 12, thereby lowering the bumper 35 into frictional engagement with the underlying surface. This inhibits movement of the base unit 12 relative to the floor or ground surface. As the user removes weight from the step stool kit 10, a biasing force causes the retractors 52 to move downwardly relative to the mounts 50, causing the base unit 12 to move upwardly, thereby disengaging the lower perimeter edge 23 from the floor or ground surface to allow the casters 54 to once again freely roll.

Reference will now be made to additional embodiments. For example, in one contemplated embodiment of the step stool kit 10, in the nested configuration, a distance between a bottom surface of the step platform 26 and the top surface of the base platform 18 may be about zero or close to zero such that the bottom surface of the step platform 26 rests against the base platform 18. Spacers may be employed to expand this distance, if desired.

In still another contemplated embodiment, the plurality of apertures 30 are defined by the base platform 18 at positions adjacent to the base legs 28. The plurality of lock tabs 16 are disposed at bottom ends of the step legs 28, and, in the multi-step configuration, the step unit 14 is in register with the base unit 12 such that the step legs 28 are aligned with the base legs 22.

It is also contemplated that, in the nested configuration, the step unit 14 is not in register with the base unit 12. Here, the step unit 14 is rotated with respect to the base unit 12 such that the step legs 28 are disposed between the base legs 22.

In another contemplated embodiment, a step stool kit 10 is capable of being assembled in the field in one way to produce a multi-step configuration and in another way to produce a nested configuration. The step stool kit 10 includes a base unit 12 with a base platform 18 supported by a plurality of base legs 22. The base unit 12 defines a first width, W, and a second width, W+1. The step stool kit 10 also includes a step unit 14 defining a third width. The step unit has a step platform 26 supported by a plurality of step legs 28. The step unit 14 is supportable by the base unit 12 when the third width is in register with the second width, W+1. In this embodiment, when the third width is in register with the second width, W+1, the step stool kit 10 has been assembled in the multi-step configuration such that the base platform 18 is disposed a first distance below the step platform 26. When the third width is in register with the first width, W, the step unit 14 has been assembled in the nested configuration such that the base platform 18 is disposed a second distance below the step platform 26. Where the second width, W+1, is less than the first width, W, and the third width is less than or equal to the first width, W, such the step unit 14 and the base unit 12 are arrangeable in the multi-step configuration and the nested configuration by displacement of the base unit 12 with respect to the step unit 14. The second distance is less than the first distance such that the multi-step configuration presents a taller profile than the nested configuration.

For this configuration, rotation of the base unit 12 with respect to the step unit 14 orients the first width, W, the second width, W+1, and the third width with respect to one another, permitting one of either the nested configuration or the multi-step configuration.

Other embodiments are intended to fall within the scope of the present disclosure. As noted above, the embodiments described herein are intended to illustrate the broad scope of the present disclosure. The enumerated embodiments are not intended to be limiting of the present disclosure.

1. A step stool kit capable of being assembled in the field in one way to produce a multi-step configuration and in another way to produce a nested configuration, the step stool kit comprising
a base unit comprising a base platform supported by a plurality of base legs, the base platform defining a plurality of apertures therein, and
a step unit comprising a step platform supported by a plurality of step legs, the plurality of step legs including a plurality of lock tabs engageable with the plurality of apertures, thereby permitting securement of the step unit atop the base unit,
wherein, when the plurality of lock tabs engage the plurality of apertures, the step stool kit has been assembled in the multi-step configuration such that the base platform is disposed a first distance above the step platform,
wherein, when the plurality of lock tabs are not engaging the plurality of apertures, the step unit is positionable in the nested configuration such that the base platform is disposed a second distance above the step platform, and
wherein the second distance is less than the first distance such that the multi-step configuration presents a taller profile than the nested configuration.

2. The step stool kit of claim 1, wherein the second distance is about zero such that a bottom surface of the step platform rests against the base platform when in the nested configuration.

3. The step stool kit of claim 1, further comprising side walls extending between adjacent ones of the plurality of base legs.

4. The step stool kit of claim 1, wherein the plurality of apertures are defined by the base platform at positions adjacent to the base legs, the plurality of lock tabs are disposed at bottom ends of the step legs, and, in the multi-step configuration, the step unit is in register with the base unit such that the step legs are aligned with the base legs.

5. The step stool kit of claim 4, wherein in the nested configuration, the step unit is not in register with the base unit, the step unit being rotated with respect to the base unit such that the step legs are disposed between the base legs.

6. The step stool kit of claim 5, wherein the base unit is triangular in shape with three step legs supporting the base platform, and the step unit is triangular in shape with three step legs supporting the step platform.

7. The step stool kit of claim 6, wherein the shape of the base unit approximates an equilateral triangle, and the shape of the step unit approximates an equilateral triangle.

8. The step stool kit of claim 3, wherein adjacent ones of the side walls form an included angle of about 60°.

9. The step stool kit of claim 1, wherein the step platform comprises a non-slip textured material.

10. The step stool kit of claim 1, wherein the base platform comprises a non-slip textured material.

11. The step stool kit of claim 1, wherein the base unit further comprises a bumper strip disposed about a bottom edge of the base unit.

12. The step stool kit of claim 1, wherein the base unit further comprises a caster unit mounted adjacent to a bottom end of each of the base legs, the caster unit comprising a mount, a retractor coupled to the mount, and a caster coupled to the retractor, the caster comprises at least one wheel, wherein the retractor permits the caster to retract when a force is applied to the base unit so that the base unit is pressed into engagement with a surface on which the base unit is disposed.

13. The step stool kit of claim 3, wherein each wall defines a foot receiver opening permitting a user to insert a portion of the user's foot therein to assist with movement of the base unit on a floor on which the base unit is disposed.

14. A step stool kit capable of being assembled in the field in one way to produce a multi-step configuration and in another way to produce a nested configuration, the step stool kit comprising
a base unit comprising a base platform supported by a plurality of base legs, the base unit defining a first width and a second width, and
a step unit defining a third width, the step unit comprising a step platform supported by a plurality of step legs, the step unit being supportable by the base unit when the third width is in register with the second width,
wherein, when the third width is in register with the second width, the step stool kit has been assembled in the multi-step configuration such that the base platform is disposed a first distance below the step platform,
wherein, when the third width is in register with the first width, the step unit has been assembled in the nested configuration such that the base platform is disposed a second distance below the step platform,
wherein the second width is less than the first width and the third width is less than or equal to the first width such the step unit and the base unit are arrangeable in the multi-step configuration and the nested configuration by displacement of the base unit with respect to the step unit, and
wherein the second distance is less than the first distance such that the multi-step configuration presents a taller profile than the nested configuration.

15. The step stool kit of claim 14, wherein rotation of the base unit with respect to the step unit orients the first width, the second width, and the third width with respect to one another, permitting one of either the nested configuration or the multi-step configuration.

16. The step stool kit of claim 14, further comprising a plurality of apertures defined by the step platform, and a plurality of lock tabs disposed at bottom ends of the step legs, and wherein the lock tabs engage the apertures when in the multi-step configuration.

17. The step stool kit of claim 15, wherein the base unit is triangular in shape with three base legs supporting the base platform, and the step unit is triangular in shape with three step legs supporting the step platform.

18. The step stool kit of claim 17, wherein the shape of the base unit approximates an equilateral triangle, and the shape of the step unit approximates an equilateral triangle.

19. The step stool kit of claim 15, further comprising a non-slip textured material disposed on at least a portion of top surfaces of both the step platform and the base platform.

20. The step stool kit of claim 18, further comprising a bumper strip disposed about a bottom edge of the base unit.
